(19) United States
(12) Patent Application Publication
(10) Pub. No.: US 2011/0061743 A1
(43) Pub. Date: Mar. 17, 2011

(54) BEVERAGE TAPPING APPARATUS, PROVIDED WITH A CHEMICAL PRESSURE GENERATOR

(75) Inventors: Mark Humphries, Great Chesterford Saffron Walden Essex (GB); John Coppendale, Stapleford Cambridgeshire (GB); David Morrison Russell, Cambridge Cambridgeshire (GB); David Richard Stonehouse, Cambridge Cambridgeshire (GB); David William Neil Edington, St Albans Hertfordshire (GB)

(73) Assignee: HEINEKEN SUPPLY CHAIN B.V., 1017 ZD AMSTERDAM (NL)

(21) Appl. No.: 12/935,048

(22) PCT Filed: Mar. 27, 2009
(86) PCT No.: PCT/NL09/50159

§ 371 Date: Dec. 2, 2010

(30) Foreign Application Priority Data
Mar. 31, 2008 (NL) 1035235

(51) Int. Cl. B67D 3/04; B65D 83/00

(52) U.S. Cl. 137/14; 137/317; 222/394

(57) ABSTRACT

A tapping apparatus 1 for beverage 7, provided with a beverage holder 2 and a pressure regulating device 9, the pressure regulating device 9 comprising a first compartment 11 and a second compartment 12, wherein the first compartment 11 contains a first substance 23 and the second compartment 12 a second substance, between the first and the second compartment at least a part of a dosing device 13 is provided and wherein at least one of the first and second compartment is in communication with an inner space 6 of the beverage holder 2. The first and second component can react with each other while forming a gas, in particular C02 gas which dissolves in the beverage 7 and pressurises the beverage holder 2.

The invention relates to a tapping device, provided with a pressure regulating device.

For dispensing beverage from beverage containers, different principles are known. For instance, use is made of gravity in gravity flow cans, use is made of external CO₂ sources, such as a gas bottle with reducing device for introducing CO₂ gas into the beverage container for pressurizing the beverage therein, and use is made of air pumps for pressurizing beverage in a bag-in-box (BIB) or bag-in-container (BIC) package. Gravity flow has as a drawback that the pressure is not constant and is furthermore low, so that a disadvantageous tapping behaviour develops, in particular in the case of, for instance, beer. Use of external CO₂ sources has as a drawback that they need to be maintained and connected while furthermore, they are to be made or kept available, which is expensive and time consuming. Furthermore, their use requires sufficient experience and special safety precautions. Use of a pump has as a drawback that an external device is required to that end, which is relatively expensive. Furthermore, in order to preserve the quality of the beverage, use of a container with an inner bag is required, which is expensive and furthermore leads to much packaging material.

In order to solve many of these problems, it has already been proposed to attach a pressure regulating device in or on the container, which pressure regulating device, during use, automatically arranges for the beverage in the beverage container to be held at a desired pressure. Such a tapping apparatus is known from, for instance, EP1170247. Here, the pressure regulating device comprises a compartment filled with CO₂ gas under pressure and a medium absorbing and/or adsorbing the CO₂ gas at least partly, such as activated carbon. Such a tapping device can be used without external pressure source for tapping beverage. However, with this device, CO₂ gas is to be introduced and held into the regulating device under pressure and to be disposed in a dosed manner.

An object of the present invention is to provide an alternative tapping apparatus, provided with a pressure regulating device for pressurizing beverage in the tapping apparatus.

In a first aspect, a tapping apparatus according to this invention is characterized in that a beverage holder and a pressure regulating device are provided, which pressure regulating device comprises at least one first compartment and one second compartment. The first compartment contains a first component and the second compartment a second component. Between the first and the second compartment, a dosing device is provided and at least one of the first and second compartments is in communication with an inner space of the beverage holder.

In one embodiment, the beverage holder can be an outer holder, such as a container, keg, BIC, BIB or other beverage containing holder.

In a second aspect, an apparatus according to this specification is characterized in that a regulating device is provided with a first compartment and a second compartment, wherein the first compartment contains a first component and the second compartment a second component. Between the first and the second compartment, a dosing device is provided and at least one of the first and second compartments is provided with a connection for an inner space of a beverage container.

In a further aspect, in this specification, a method is characterized for regulating pressure in a tapping apparatus, wherein, with a pressure reduction in a beverage comprising beverage holder, a first component is brought into contact with a second component, such that these components can react with each other while forming a gas, with which gas the pressure in the beverage holder is increased.

Apparatuses and methods according to this specification will be further elucidated on the basis of the Figures. In the Figures:

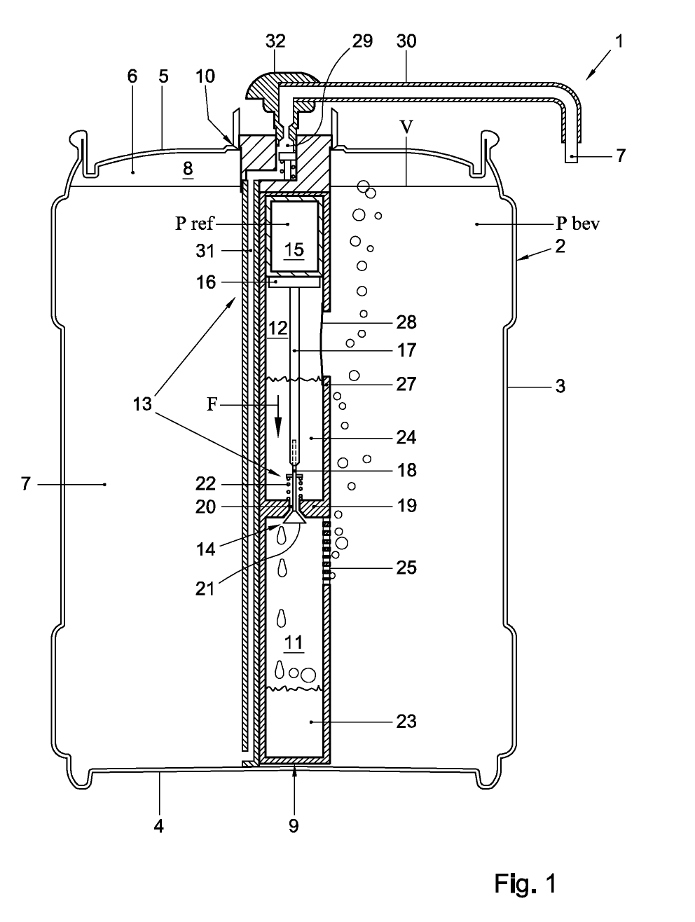

FIG. 1 schematically shows, in cross-sectional side view, a tapping apparatus according to the description;

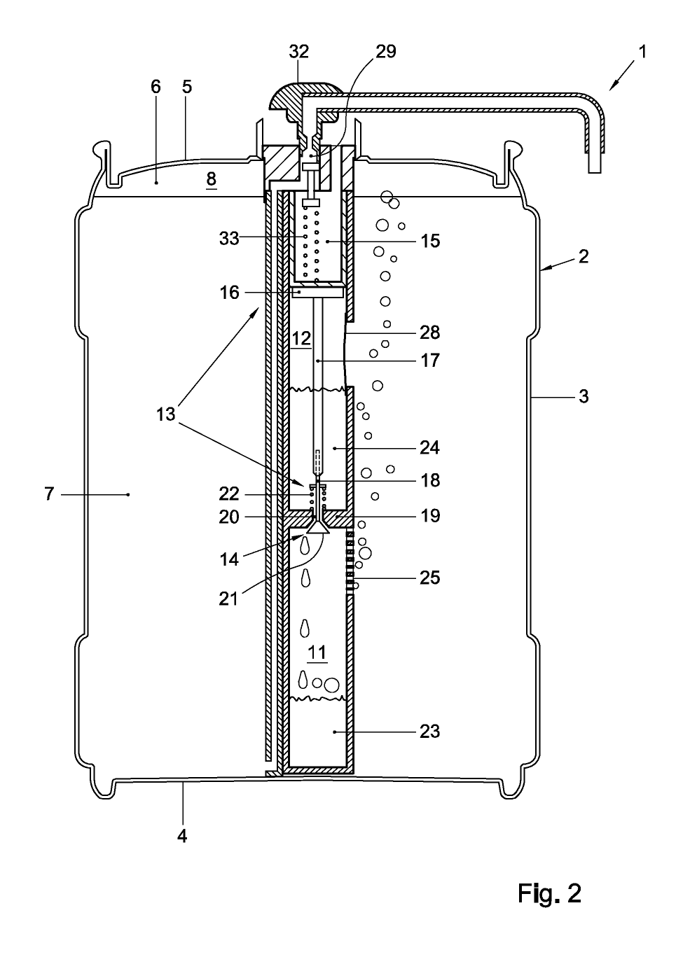

FIG. 2 schematically shows, in cross sectional side view, a second embodiment of a tapping apparatus according to the description;

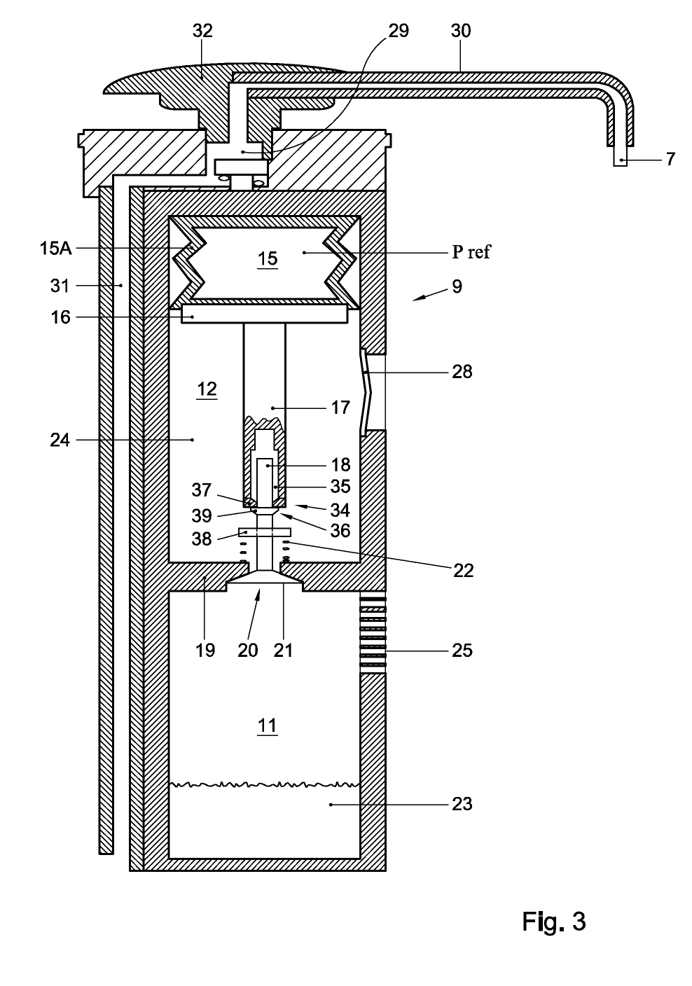

FIG. 3 shows, schematically and in cross section, a pressure regulating device;

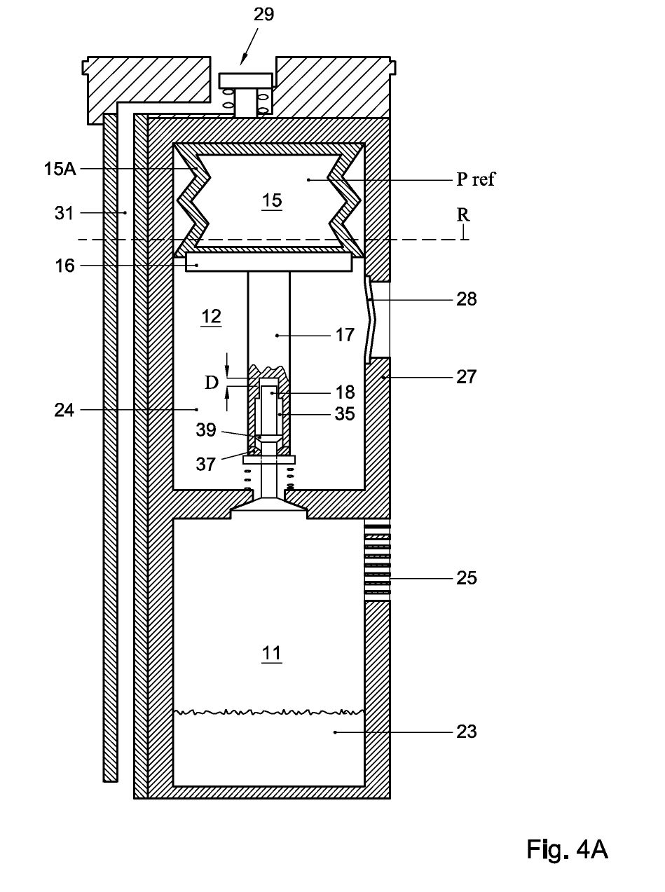

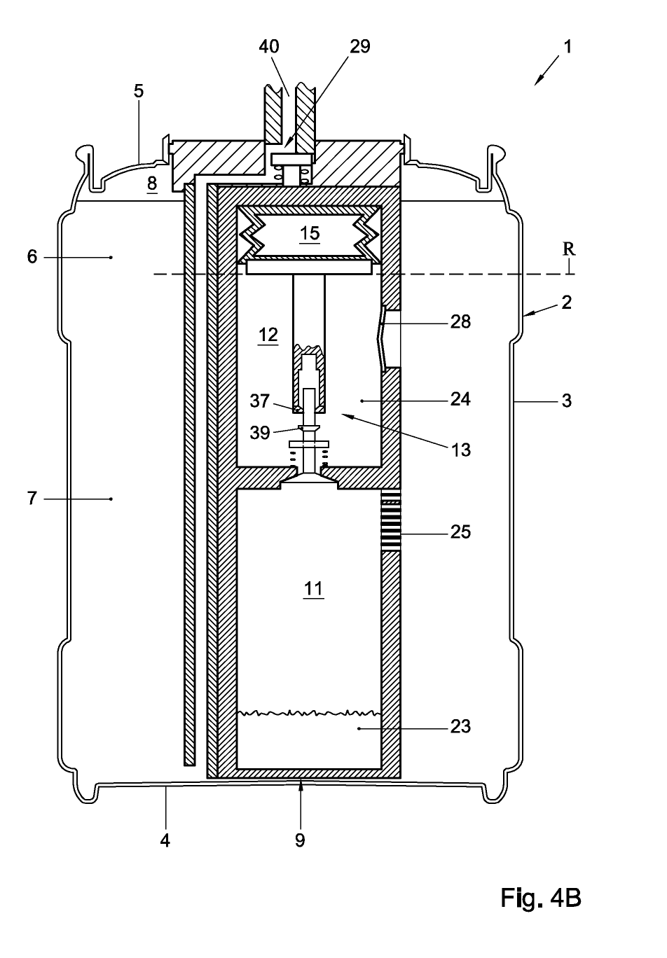

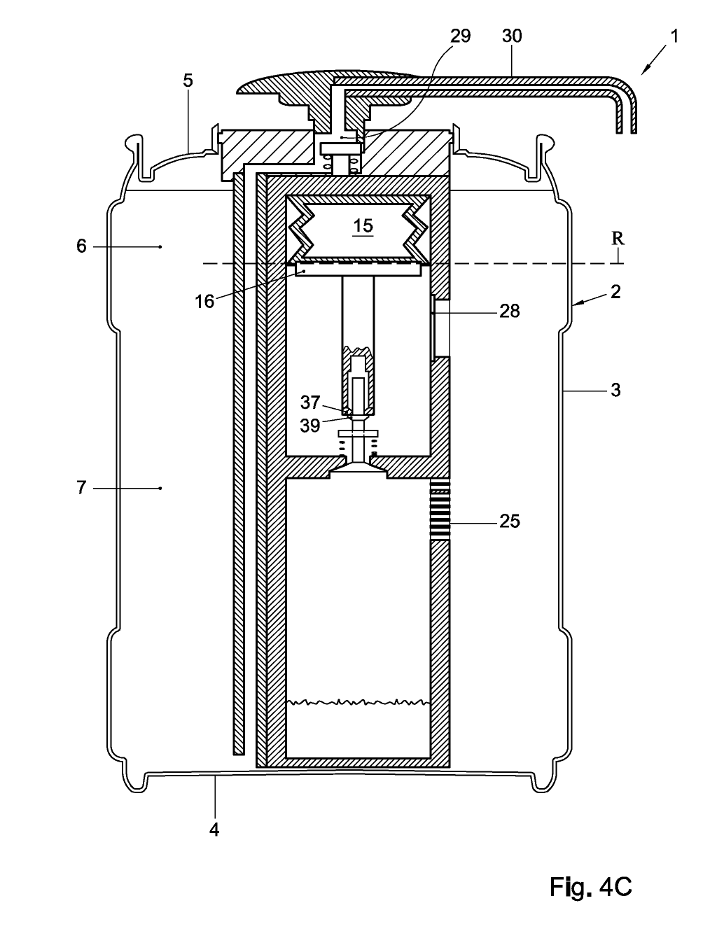

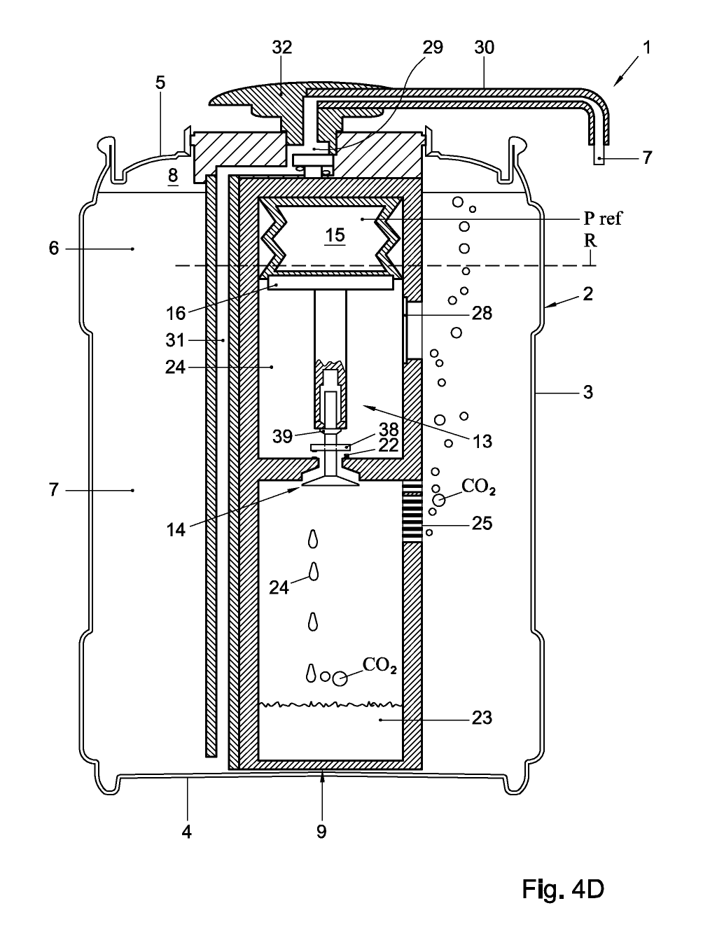

FIGS. 4A-D show four steps in the use of a tapping apparatus according to FIG. 1 or 2; and

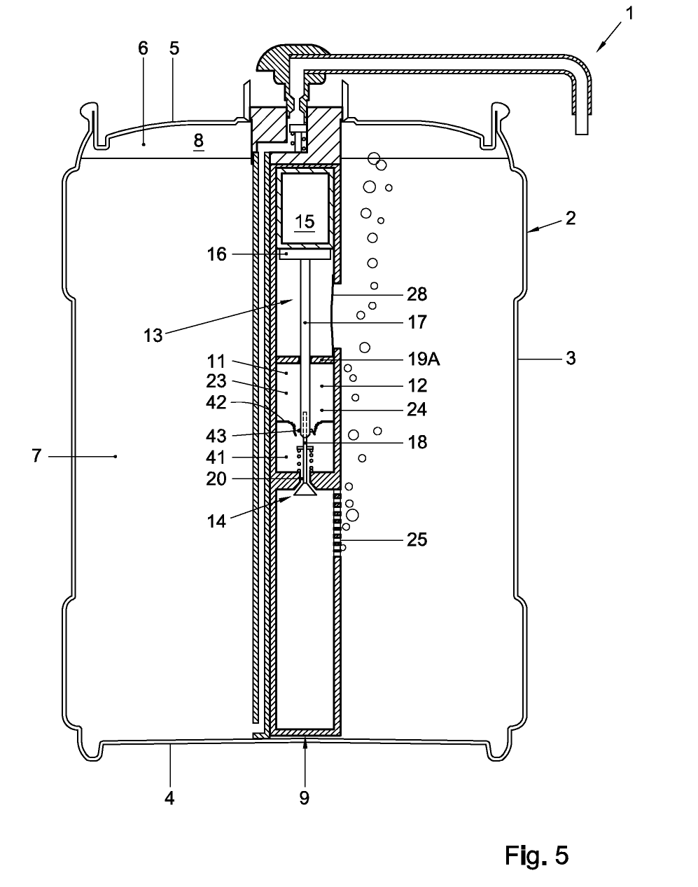

FIG. 5 shows a further alternative embodiment of a tapping apparatus according to the description.

In this specification, identical or corresponding parts have identical or corresponding reference numerals. The embodiments shown and described are shown merely by way of illustration and should not be construed to be limitative in any manner. In this specification, the starting point will be a carbonated (CO₂) beverage, in particular beer, such as a lager beer. However, the invention is not limited thereto. In the exemplary embodiments shown, in each case, a beverage holder is shown and described which is substantially cylindrical, with a bottom and a cover. Tapping means extend at least partly above and/or through the cover. However, the tapping means can also be at a different position, for instance in a sidewall adjacent the cover, a central area of the sidewall and/or in or adjacent the bottom, while the beverage holder can also have a different shape. The beverage holder can be manufactured from metal, plastic, glass or a combination thereof, or other suitable materials. The beverage holder can also comprise an inner holder, such as a bag, in which the beverage is included. The gas can be dispensed directly into the beverage but can for instance also inflate a bag in the beverage and/or compress a bag around the beverage so that beverage is pressurized without direct contact between the beverage and the gas.

In this specification, dosing is to be understood as at least comprising but not limited to joining components in measured quantities and/or specific joining of components.

With a package according to the invention, preferably, no external pressure source is required. What is thus prevented is that an external pressure source is to be connected to the package, or that the use of the package depends on the availability of this external pressure source, which would render flexible use particularly hard or even impossible, while furthermore, such an external pressure source is often cost-increasing.

In FIG. 1, in cross-sectional side view, a tapping apparatus 1 is shown. The tapping apparatus 1 comprises a beverage holder 2, manufactured in this embodiment as a metal or plastic can. In other embodiments, the beverage holder can be manufactured from a combination of metal and/or plastic and/or paper or cardboard. In the embodiment shown, the beverage holder 2 comprises a wall 3, a bottom 4 and a cover 5. In one embodiment, these can be mutually connected by for instance known folding, welding or gluing techniques or otherwise. In another embodiment, different parts can be integrally manufactured. In the beverage holder 2, an inner space 6 is provided in which beverage 7 can be included. A head space 8 can then be provided above the level V of the beverage 7.

The tapping apparatus 1 is provided with a regulating device 9. In the exemplary embodiment shown, the regulating device 9 is inserted through an opening 10 in the cover. In this and other embodiments, the regulating device can extend wholly or partly in the inner space 6 or be provided wholly or partly outside the tapping apparatus 1, while a gas connection will be provided between the regulating device 9 and the inner space 6.

In the embodiment shown in FIG. 1, the regulating device 9 comprises a first compartment 11 and a second compartment 12 located at least partly thereabove. In another embodiment, the second compartment 12 can be located next to or below the first compartment 11. In a further embodiment, different first 11 and/or second compartments 12 can be provided. In the regulating device 9, a dosing device 13 may be provided. In one embodiment, the dosing device can comprise a valve 14, which, in an opened position such as shown in FIG. 1, can connect the second compartment 12 to the first compartment 11 and, in a closed position, separates the second compartment 12 from the first compartment 11. In one embodiment, as shown in FIG. 1, the dosing device 13 can be pressure-controlled. In one embodiment, the dosing device 13 comprises to that end a pressure controlled valve 14. In one embodiment, the dosing device 13 can be provided with a chamber 15 with at least one wall part 16 movable relative to the chamber 15. In one embodiment, the wall part 16 can form or comprise a piston. In another embodiment, the wall part 16 can be wholly or partly deformable, for instance elastically deformed, and may be formed from plastic or metal. The movable wall part 16 offers the possibility that the volume of the chamber 15 can change. In different embodiments, the volume of the chamber 15 can change through displacement of and/or deformation of the wall part 16 relative to the further chamber 15. In embodiments, the volume can change under the influence of for instance, but not limited to pressure change in the inner space 6, pressure change in the first compartment 11, pressure change in the second compartment 12, pressure change in the chamber 15 and/or through mechanical influencing of the wall part 16 and/or the chamber 15, or a combination of two or more of these effects.

In the exemplary embodiment represented in FIG. 1, the chamber 15 is provided above the second compartment 12. However, this can also be provided at a different position, for instance between the two compartments 11, 12 or below the lower compartment 11.

In the exemplary embodiment shown in FIG. 1, the wall part 16 is provided at an underside of the chamber 15 while the chamber 15 is placed on a side of the second compartment 12 opposite the first compartment 11. A rod 17 is provided between the wall part 16 and a valve rod 18 of the valve 14. Between the first compartment 11 and the second compartment 12, a partition wall 19 is provided in which an opening 20 is provided that can be sealed off by the valve 14. Between the partition wall 19 and the dish 21 on the valve rod 18 a spring 22 is provided, whereby the valve 14 is biased in the closed position. When pressure is exerted by the rod 17 on the valve rod 18, in the direction F away from the chamber 15, the spring 22 is compressed to some extent and the opening 20 is at least partly cleared by the valve 14, so that a fluid communication is formed between the second compartment 12 and the first compartment 11. If the pressure of the rod 17 on the valve rod 18 is removed, for instance in that the wall part 16 in FIG. 1 moves upwards, the spring 22 will press the valve 14 in the direction of the closed position, optionally supported by pressure in the first compartment 11.

In the first compartment 11, a first component 23 can be included, in the second compartment 12 a second component 24. In this specification, with regard to the first and second component 23, 24, component is understood to mean at least but no exclusively single chemicals or compounds of chemicals, which can be provided in solid form, liquid form, suspension and/or solution. The first component 23 and the second component 24 can be selected such that they can react with each other and/or with a further component, such as for instance but not limited to water, beer, soft drink, while forming a gas. In one embodiment, the first and second component 23, 24 can react, optionally together with one or more further components, while forming carbon dioxide (CO₂). In one embodiment, the first component 23 can be a solid or a liquid. The second component 24 can for instance be a liquid, a solution or suspension. The first and/or second component 23, 24 can comprise different substances, for instance a mixture or a solution. In one embodiment, the first component 23 can comprise a (bi-) carbonate, and the second component 24 an acid, for instance an acid/water solution.

One of the compartments 11, 12 can be in communication with the inner space 6 of the beverage holder 2, in particular a compartment 11, 12 in which during use a gas will develop. In one embodiment, the first compartment 11 can be provided with at least one passage in which a membrane 25 is included. The membrane 25 is for instance gas-transmissive yet liquid-tight. The membrane 25 can be a hydrophobic membrane. A non-limitative example of such a membrane 25 is stretched PTFE foil, commercially available under the brand name Goretex®.

In one embodiment, in the chamber 15, a reference pressure P_{ref} can prevail, for instance a pressure P_{ref} which corresponds to a desired pressure P_{bev} in the inner space 6. In an alternative embodiment, in the chamber 15 between the movable wall part 16 and the opposite wall 26 of the chamber 15, a spring can be provided (comparable to FIG. 2) which exerts a bias on the wall part 16 when the valve 14 is closed. With it, the pressure in the chamber can be reduced and still a desired pressure can be exerted in the direction of the wall 19. When a spring is used in this manner, optionally there can be a direct, open communication between the surrounding atmosphere and the chamber, so that the outside air (atmospheric pressure) can function as pressure in the chamber 15.

In the exemplary embodiment shown in FIG. 1, in the wall 27 of the second compartment 12, a second membrane 28 is provided. In one embodiment, this second membrane 28 can be liquid-tight and gas-transmissive. In such an embodiment, it can be a hydrophobic membrane. A non-limitative example of a material for manufacturing at least one part of such a membrane 28 is stretched PTFE foil, commercially available under the brand name Goretex®. In such an embodiment, the pressure in the second compartment 12 will be virtually equal to that in the beverage containing inner space 6. With a pressure drop in the inner space 6, as a result of, for instance, reduction of the amount of beverage therein, the pressure in the second compartment 12 will also fall, so that the wall part 16 with the rod 17 will move in the direction of the first compartment 11 and the valve 14 will open. As a result, a part of the second component 24 will be added to the first compartment 11 to the first component 23 and cause gas to develop. This gas will flow into the inner space 6, through the membrane 25, and increase the pressure therein to the desired pressure P_{bev}. With this, the pressure in the second compartment 12 increases again too such that the wall part 16 is pressed upward again and the valve 14 is closed.

In an alternative embodiment, the second membrane 28 can be liquid-tight and gastight and be of flexible or movable design. With pressure difference between the beverage containing inner space 6 of the beverage holder 2 and the second compartment 12, the second membrane 28 may deform and thus influence the pressure in the second compartment 12. With a pressure drop in the inner space 6, the second membrane 28 will move outwards, i.e. in the direction of the inner space 6, whereby the volume of the second compartment increases and therefore the pressure decreases. Thus, in the above-described manner, the valve 14 is opened through movement of the wall part 16. Gas will develop in the first compartment 11, so that the pressure in the inner space will be returned towards, to or even be slightly higher than the desired pressure P_{bev}. As a result, the second wall part 28 is pressed back in the direction of the second compartment 12, the valve is closed again and the equilibrium is restored.

In the embodiment shown in FIG. 1, above the regulating device, a valve 29 is provided. In one embodiment, this can be a valve as used in aerosol containers. However, any suitable type of valve can be used to this end. On the outside of the beverage holder 2 a dispensing tube links up with the valve 29, while on the side proximal to the inner space 6, a riser 31 is provided which reaches from the underside of the valve 29 to adjacent the bottom 4 of the beverage holder 2. During use, the valve 29 can be pressed down, for instance with the aid of an operating button 32, whereby it is opened. As the pressure P in the inner space 6 has been brought to the desired pressure P_{bev}, when the valve 29 is opened, beverage will flow away from the inner space via the riser 31, the valve 29 and the dispensing tube 30, so that the above-described pressure drop occurs which is compensated in the described manner through reaction of the first and second component 23, 24 in the suitable proportion, so that the pressure in the inner space 6 is returned to the desired pressure P_{bev}.

Preferably, the regulating device 9, together with the valve 29 and the riser 31, is designed as a unit which can be integrally arranged in the beverage holder 2.

In FIG. 2, schematically, in cross-sectional view, a tapping apparatus 1 according to the invention is shown, in an alternative embodiment. Identical parts have identical reference numerals. In this embodiment, the dosing device 13 is designed such that upon operation of the operating button 32 for opening the valve 29, also the rod 17 is moved, so that the valve 14 can be opened so that the second component 24 can be added in a desired extent to the first component 23. In one embodiment, the rod 17 can directly be connected to for instance a moving part of the valve 29 or the operating button 32 or abut thereagainst, so that a downward movement of the operating button 32 for opening the valve 29 simultaneously opens the valve 14. In a variant shown in FIG. 2, between the wall part 16 connected to the rod 17 and the valve 29 or the operating button 32 a spring 33 is provided. When pushing in the operating button 32 for opening the valve 29, the spring 33 will be compressed when the pressure in the second compartment 12 is higher than approximately the desired pressure P_{bev}. Only when the pressure in the second compartment 12 is lower then the desired pressure Pᵣₑₜ, the spring 33 will press the wall 16 away and downwards and open the valve 14. As a result, the valve 14 is prevented from being opened when the pressure in the inner space 6 is sufficiently high.

In FIG. 3, a further embodiment of a pressure regulating device 9 is shown, which is substantially equal to the one in FIG. 1 but can also be designed as shown in FIG. 2. This embodiment is described only in so far as it does not correspond with the above-described embodiments.

In this embodiment, the chamber 15 is designed as a bellows 15A. Such a bellows can be manufactured from, for instance, plastic or metal. Metal offers the advantage that it is gastight without special measures having to be taken. The bellows 15A has a flexible concertina wall so that the wall part 16 is movable. Such a bellows can be used in the embodiments of FIG. 1, 2 or 5 while in a chamber 15 an embodiment of FIG. 3 can also be used in an apparatus according to FIG. 1, 2 or 5. The rod 17 is coupled to the wall part 16, which rod 17 is provided, on the end remote from the wall part 16, with a bore 35. This bore can be an axial bore. The valve rod 18 runs into the bore 34. Adjacent the open side 36 of the bore 34 a restriction 37 is provided, for instance a ring element which is somewhat flexible. In FIG. 3, the regulating device 9 is shown in a position of use, as will be described further. On the valve rod, a spring plate 38 is provided, against which the spring 22 bears. On the side of the plate 38 remote from the wall 19, a stop element such as a ring 39 is provided with a conical form tapering in the direction of the plate 38. In the position of use shown in FIG. 3, this abuts against the outside of the restriction 37. As a result, the valve 14 can be opened by moving the wall part 16 in the direction of the wall 19.

In FIGS. 4A-D, schematically, it is shown in four steps how a tapping apparatus 1 can be set and used, in particular but not limited to an embodiment having a regulating device according to FIG. 3.

In FIG. 4A, a regulating device 9 is shown in inactive position. The regulating device 9 is preferably in this position prior to filling of the beverage holder 2. In this condition, pressure change in the compartments 11, 12 and/or in the inner space 6 or the chamber 15 cannot lead to opening of the valve 14. To that end, the stop element 39 is pressed beyond the restriction 37 in the bore 34, such that the valve rod 18 can move freely over a range D with respect to the rod 17. Pressure changes in the inner space 6 with respect to the reference pressure P_{ref} in the chamber 15 will therefore indeed move the rod 17 but within the pressure changes that can be expected, the rod 17 will not carry the valve rod 18 along and the valve 14 will therefore not be opened. Therefore, the first and second component 23, 24 will not be joined and no gas development will be obtained.

In FIGS. 4A-D, an interrupted line R has been drawn at the location of the position of the wall part 16 when the reference pressure P_{ref} in the chamber 15 and the pressure in the second compartment 12 are at an equilibrium, with the pressure regulating device 9 in active position. As shown in FIG. 4A, in the inactive position, the wall part 16 is preferably under this line R.

In FIG. 4B, a supply tube 40 is placed on the valve 29. With it, an excess pressure is provided in the inner space 6, for instance by introducing a small amount of CO₂ gas into the inner space. As a result, the pressure in the second compartment 12 is increased to clearly above the reference pressure P_{ref}. The wall 16 is moved above the line R, i.e. in the direction of the cover 5. As a result, the rod 17 is moved along the valve rod 18, such that the stop element 39 is pulled through the restriction 37 which is simplified by the conical shape thereof. In this condition, the regulating device 9 is activated. A part of the additional CO₂ will be absorbed by the beverage, so that the pressure drops to some extent and the wall part 16 moves down again, approximately to the line R as shown in FIG. 4C. Here, the restriction comes to lie at the top of the stop element 39.

In FIG. 4D, it is shown that the valve 14 is opened during tapping. To that end, the operating button 32 is moved downwards so that beverage can flow away via the riser, valve and dispensing tube. As a result, the pressure in the inner space 6 will be reduced, with corresponding or at least representative reduction of the pressure in the second compartment 12. Owing to this pressure reduction, the wall part 16, as a result of the reference pressure P_{ref} in the chamber and/or the pressure through the spring arranged therein, will be moved down again in the second compartment 12. Here, the rod 17 pushes the valve rod 18 down and opens the valve 14. Then, an amount of the second component 24 flows via the valve 14 into the first compartment 11 and mixes and reacts with the first component 23 present therein, so that a desired amount of gas develops. This gas will flow at least substantially through the first membrane 25 and optionally along the valve 14 and via the second membrane 28 into the inner space 6 and into the second compartment 12, increasing the pressure proportionally. As a result, the wall part 16 is pressed back to the line R and the spring 22 will close the valve 14. Thus, the development of gas and the associated pressure increase are stopped.

In FIG. 5, a further alternative embodiment of a regulating device according to the invention is shown. In this embodiment, the first and second component 23, 24 are provided in side-by-side compartments 11, 12. A rod 17 of the dosing device 13 is connected, on the one side, to the wall part 16 of the chamber 15 and, on the other side, to the valve 14. Below the two compartments 11, 12 a third compartment 41 is provided, which is separated via a sealing 42 such as a foil or valves (not shown) from the first and second compartment 11, 12, respectively. The rod 17 is provided with an element 43 for opening the sealing 42, so that the first and second component 23, 24 are added to the third compartment 41. By opening the sealing 42 to a greater or lesser extent, the mixing of the components can be regulated in a dosed manner. Preferably, opening the sealing 42 is obtained by a user, for instance when the operating button is pushed in for the first time. The wall part 16 is separated from the first and second compartment 11, 12 by a partition wall 19A through which the rod 17 extends. It will be clear that gas development will occur when the components 23, 24 mix. As a result, the pressure in the compartments 11, 12, 41 will increase. When in the inner space 6 the pressure decreases the wall part 16 will move downwards and thus open the valve 14. As a result, gas under pressure is allowed from the compartments 11, 12, 41 into the inner space 6 for bringing the pressure therein back to almost the desired pressure.

By way of illustration, an example will be described of used components 23, 24, which example should not be construed to be limitative in any manner. Depending on the desired use, the skilled person will be able to each time select a suitable set of components in a simple manner without further invention.

In one embodiment, as a first component 23, sodium bicarbonate is used and as second component citric acid. Upon mixture, this gives a chemical reaction with the following components:

3NaHCO₃+C₆H₈O₇→3CO₂+3H₂O+Na₃C₆H₅O₇

For instance 84 g of sodium bicarbonate and 64 g of citric acid can yield 12 litres of CO₂, at 2 bars pressure. 35 g sodium bicarbonate and 27 g of citric acid yield approximately 5 litres of CO₂ at approximately 2 Bar. By way of illustration, another possible reaction can be

NaHCO₃+KHC₄H₄O₆+H₂O→+KNaC₄H₄O₆+H₂CO₃+H₂O

H₂CO₃ [symbol] H₂O+CO₂

For instance 84 g of sodium bicarbonate and 188.2 g of potassium bitartrate yield approximately 12 litres of CO₂ at approximately 2 bar pressure. 35 g of sodium bicarbonate and 78.4 g of potassium bitartrate give approximately 5 litres of CO₂ at approximately 2 bar pressure.

It will be clear that a skilled person can select suitable amounts of chemicals depending on, inter alia, the amount of liquid (beverage) to be dispensed, desired dispensing pressure, flow resistances, temperature and the like.

Naturally, other chemicals and combinations thereof can be utilized, such as (bi) carbonates and acids and/or bases. Acids can for instance be selected from a group comprising but not limited to calcium phosphate and lactic acids, bases can be selected from, for instance, a group comprising but not limited to potassium bicarbonate and calcium carbonate. As reference pressure P_{ref} a pressure between 0.5 and 1.2 bar excess pressure can for instance be utilized, more particularly between 0.7 and 1.0 bar excess pressure. In an advantageous embodiment, a reference pressure of approximately 0.9 excess pressure or approximately 1.09 bar absolute is used. Such a pressure can be somewhat higher than the equilibrium pressure for CO₂ gas that is ideal for the beverage, while it can thus be achieved that the pressure in the inner space can be raised somewhat above such an equilibrium pressure, and therefore the regulating device will switch on less often. However, naturally, the reference pressure can also be set to the equilibrium pressure, for instance approximately 1.4 to 1.6 bar absolute. Alternatively, a first and second component can be selected which substantially enter into an equilibrium reaction such as for instance an acid and a buffer. Such reactions are described in, for instance, WO 2008/000272, for instance on p. 4 and the examples. Such a combination of components is in particular but not exclusively suitable in an embodiment according to FIG. 5 of the present specification.

The invention is not limited in any manner to the embodiments represented in the specification. Many variations thereon are possible within the framework of the invention as outlined by the claims. For instance, the chamber 15 can be fixedly connected to the rod 17, while the movable wall part 16 is provided on the side of the valve 29 and the entire chamber 15 moves with pressure changes. Other components can be utilized for forming CO₂ or a different propellant. The regulating device 9 can be provided at other positions, optionally in combination with the valve and/or the riser. The regulating device can also be placed at a distance from the valve, for instance in the bottom or wall or outside the beverage holder, as long as gas can be introduced from the regulating device into the beverage holder.

1. A tapping apparatus for beverage, provided with a beverage holder and a pressure regulating device, which pressure regulating device comprises at least one first and one second compartment, wherein the first compartment contains a first component and the second compartment a second component, wherein between the first and the second compartment at least a part of a dosing device is provided and wherein at least one of the first and second compartment is in communication with an inner space of the beverage holder.

2. A tapping apparatus according to claim 1, wherein the first and second component can react with each other while forming a gas, in particular CO₂ gas.

3. A tapping apparatus according to claim 1, wherein the first component is a solid or a liquid.

4. A tapping apparatus according to claim 3, wherein the second component is a liquid.

5. A tapping apparatus according to claim 1, wherein the dosing device comprises a valve which can be opened and closed with the aid of a pressure regulator which is regulated by pressure changes in the inner space of the beverage holder.

6. A tapping apparatus according to claim 5, wherein the pressure regulator comprises a wall part which seals off a chamber at least partly and is movable with respect to this chamber, wherein on one side of the wall part a pressure prevails associated with the pressure prevailing in the inner space of the container, wherein the wall part is connected to or can be connected to the valve, for opening and closing a passage between the two compartments.

7. A tapping apparatus according to claim 1, wherein one of the first and the second compartment is provided with a membrane which is gas-transmissive but liquid-tight, for forming the connection between the respective compartment and the inner space of the beverage holder.

8. A tapping apparatus according to claim 7, wherein the membrane is a hydrophobic membrane.

9. A tapping apparatus according to claim 1, wherein the beverage holder comprises a bottom, wherein the first compartment is arranged in an area between the second compartment and the bottom.

10. A tapping apparatus according to claim 1, wherein the first component comprises carbonate and the second component an acid.

11. A tapping apparatus according to claim 10, wherein the carbonate is a sodium carbonate and the acid a citric acid, in particular a citric acid in aqueous solution.

12. A tapping apparatus according to claim 1, wherein the dosing device is connected to a tap, such that if via the tap beverage is tapped from the tapping apparatus, an amount of the first component is added to the second component.

13. A tapping apparatus according to claim 1, wherein a series of first and/or second compartments is provided.

14. A tapping apparatus according to claim 1, wherein the compartment which is in communication with the inner space has a volume in which through reaction of the first component with the second component gas development can take place such that as a result thereof the pressure in the respective compartment rises and a passage between the first and second compartment can be closed.

15. A tapping apparatus according to claim 1, wherein the beverage holder is provided with an opening, wherein the regulating device has been inserted through said holder into the beverage holder and is preferably suspended in the opening.

16. A tapping apparatus according to claim 1, wherein the regulating device is provided with a tap and a riser, connected to the tap and inserted into the beverage holder.

17. A regulating device, provided with a first compartment and a second compartment, wherein the first compartment contains a first component and the second compartment a second component, wherein between the first and the second compartment a dosing device is provided and wherein at least one of the first and second compartment is provided with a connection for an inner space of a beverage holder.

18. A regulating device according to claim 17, wherein the dosing device is pressure controlled.

19. A regulating device according to claim 17, wherein the dosing device comprises a valve.

20. A housing for a regulating device for introducing a pressure gas into a beverage container, wherein at least one compartment is provided having a wall part which is liquid-tight and gas-transmissive.

21. A housing according to claim 20, wherein said wall part is at least partly manufactured from hydrophobic material, preferably a hydrophobic membrane.

22. A method for regulating pressure in a tapping apparatus, wherein upon pressure reduction in a beverage comprising beverage container a first component is brought into contact with a second component such that these components can react with each other while forming a gas, with which gas the pressure in the beverage holder is increased.

23. A method according to claim 22, wherein at least one of the first and second component is added to the other of the first and the second component in a dosed manner.

24. A method according to claim 23, wherein said dosing is adjusted to the pressure reduction in the beverage holder.

25. A method according to claim 23, wherein said dosing is obtained through operation of an operating element by a user.
